(19) United States
(12) Patent Application Publication
(10) Pub. No.: US 2006/0103896 A1
(43) Pub. Date: May 18, 2006

(54) Duplex scan apparatus

(76) Inventor: Hsing-Lu Chen, Hsinchu City (TW)

Correspondence Address: RABIN & Berdo, PC, 1101 14TH STREET, NW, SUITE 500, WASHINGTON, DC, 20005, US

(21) Appl. No.: 11/273,028

(22) Filed: Nov. 15, 2005

(30) Foreign Application Priority Data
Nov. 15, 2004 (TW) 93134989

(51) Int. Cl. H04N 1/04

(52) U.S. Cl. 358/474

(57) ABSTRACT

A duplex scan apparatus includes an ASIC for outputting timing, a first CCD, a second CCD, a first AFE, and a second AFE. The first CCD is for sensing the first face of the to-be-scanned document and outputting first image data according to the timing. The second CCD is for sensing the second face of the to-be-scanned document and outputting second image data according to the timing. The first AFE is for converting the first image data into first digital data and outputting the digital data to the ASIC for processing. The second AFE is for converting the second image data into second digital data and outputting the digital data to the ASIC for processing. A constant data amount corresponding to the timing is a sum of a first data amount of the first digital data and a second data amount of the second digital data.

This application claims the benefit of Taiwan application Serial No. 93134989, filed Nov. 15, 2004, the subject matter of which is incorporated herein by reference.

### BACKGROUND OF THE INVENTION

1. Field of the Invention

The invention relates in general to a duplex scan apparatus, and more particularly to a duplex scan apparatus, using a single application specific integrated circuit (ASIC) to simultaneously process the image data generated in duplex scan.

2. Description of the Related Art

FIG. 1 is a partial block diagram of a conventional duplex scanner. Referring to FIG. 1, the duplex scanner 100 includes a first ASIC 110 and a second ASIC 120, a first analog front end (AFE) 112 and a second AFE 122, and a first charge coupled device (CCD) 114 and a second CCD 124. The CCDs 114 and 124 respectively sense the upper face and the lower face of a to-be-scanned document (not shown in the figure) according to scan data amount request of the timing T1 and T2 output by the ASICs 110 and 120, convert the captured analog image data Di1 and Di2 into digital image signals Sd1 and Sd2 by using the AFEs 112 and 122, and transmit the image signals Sd1 and Sd2 to the ASICs 110 and 120 for data processing.

For example, the ASICs 110 and 120 respectively send out the timing T1 and T2 of 1200 dpi. The CCDs 114 and 124 capture 1200 points of image data Di1 and Di2 each for the upper face and the lower face of the to-be-scanned document according to the timing T1 and T2. The duplex image scan requires two ASICs to respectively process image data captured by two CCDs, and then the processed image data are transmitted to a computer for generating an image file, thereby increasing manufacturing cost.

### SUMMARY OF THE INVENTION

It is therefore an object of the invention to provide a duplex scan apparatus. By using a single ASIC to simultaneously process the image data generated in duplex scan, the manufacturing cost can be effectively reduced.

The invention achieves the above-identified object by providing a duplex scan apparatus for simultaneously scanning a first face and a second face of a to-be-scanned document. The duplex scan apparatus includes an ASIC for outputting timing, a first CCD, a second CCD, a first AFE, and a second AFE. The first CCD is for sensing the first face of the to-be-scanned document and outputting first image data according to the timing. The second CCD is for sensing the second face of the to-be-scanned document and outputting second image data according to the timing. The first AFE is for converting the first image data into first digital data and outputting the digital data to the ASIC for processing. The second AFE is for converting the second image data into second digital data and outputting the digital data to the ASIC for processing. A constant data amount corresponding to the timing is a sum of a first data amount of the first digital data and a second data amount of the second digital data. Therefore, using a single ASIC to process simultaneously the image data of two CCDs can effectively reduce the cost.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a partial block diagram of a conventional duplex scanner.

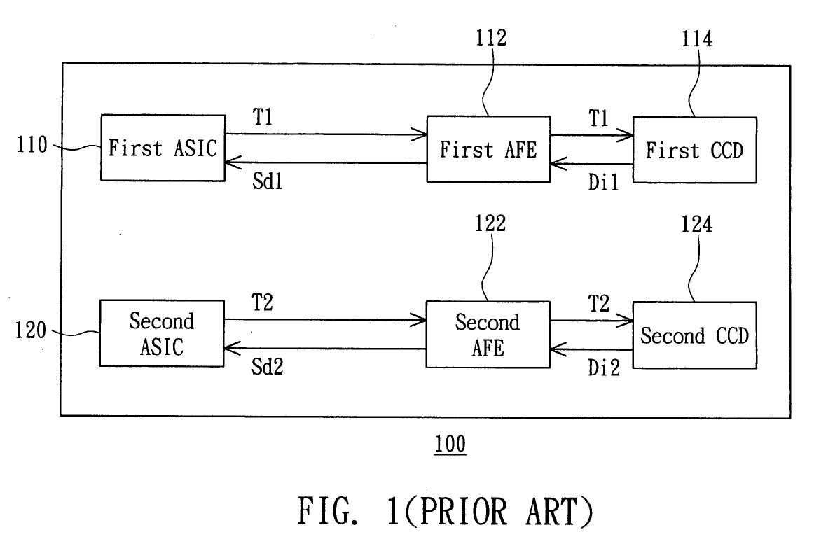

FIG. 2 is a partial block diagram of a duplex scan apparatus according to a preferred embodiment of the invention.

FIG. 3 is a schematic diagram showing the time for processing data captured by two CCDs by using a single ASCI.

FIG. 4 is a comparison diagram of the timing T sent out by the ASIC and the signals Sd1 and Sd2 sent back by the AFEs according to the preferred embodiment of the invention.

### DETAILED DESCRIPTION OF THE INVENTION

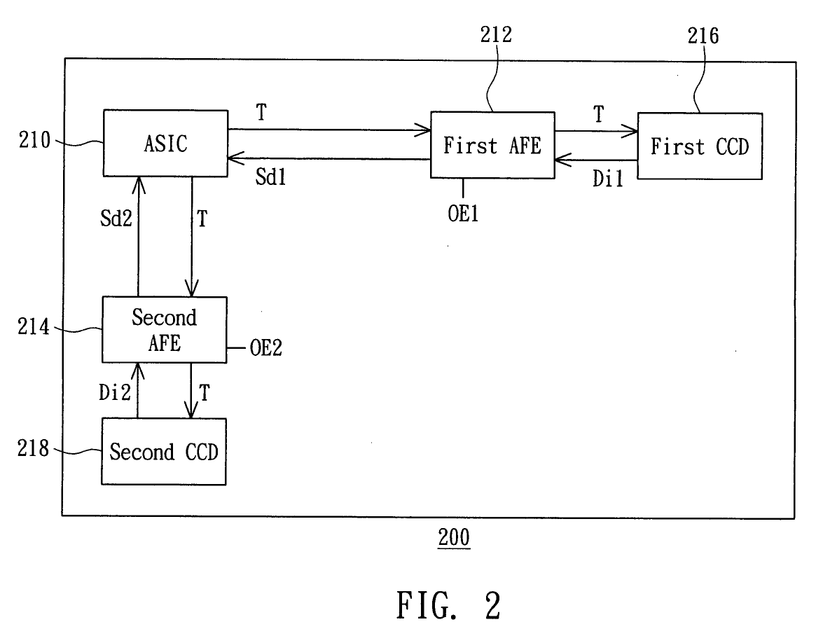

Referring to FIG. 2, a partial block diagram of a duplex scan apparatus according to a preferred embodiment of the invention is shown. The duplex scan apparatus 200 includes an ASIC 210, a first AFE 212 and a second AFE 214, and a first CCD 216 and a second CCD 218. The CCDs 216 and 218 senses the upper face and the lower face of a to-be-scanned document (not shown in the figure) by a scan data amount according to the timing, convert the captured analog image data Di1 and Di2 by the AFEs 212 and 214 into digital image signals Sd1 and Sd2, and then transmit the image signals Sd1 and Sd2 to ASIC 210 for data processing.

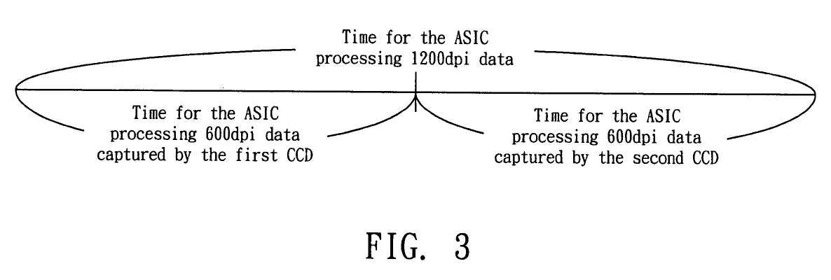

Different from the prior art, the invention uses a single ASIC 210 to process the image data captured by the two CCDs 216 and 218. As shown in FIG. 3, 600 dpi duplex scan is taken as an example. By the principle of processing 1200 dpi image data, the ASIC 210 sends out the timing T of 1200 dpi to the CCDs 216 and 218 respectively used for the first CCD 216 and the second CCD 218 to capture 600 dpi image data.

As mentioned above, the duplex scan apparatus 200 according to the embodiment of the invention can use a single ASIC 210 to process the image data Di1 and Di2 output by the two CCDs 216 and 218 because the first AFE 212 and the second AFE 214 respectively include an output enable port OE1 and an output enable port OE2, and the ASIC 210 not only informs data amount of the image data Di1 and Di2 to be captured but also control the OE1 of the AFE 212 and the OE2 of the AFE 214 to respectively capture odd-numbered digital image data Sd1 and even-numbered digital image data Sd2 converted from the image data Di1 and Di2. For example, the timing T is 1200 dpi, and the CCDs 216 and 218 respectively capture 1200 dpi data Di1 and Di2. The captured data Di1 and Di2 are partially deleted vie the OE1 and OE2 and 600 dpi digital data of signals Sd1 and Sd2 are remained and sent back to the ASIC 210.

After the 600 dpi digital data Da1 and 600 dpi digital data Da2 selected off the signals Sd1 and Sd2 through data deletion of OE1 and OE2 are input to the ASIC 210, they can be processed in turn by spacing at a constant number of data, such as Da1, Da2, Da1, Da2, . . . , or Da1, Da1, Da2, Da2, Da1, Da1, Da2, Da2, . . . . Or all the 600 dpi data Da2 are processed before the 600 dpi data Da1, that is, Da2, Da2, . . . , Da1, Da1.

Moreover, the ASIC 210 can also send out the timing T to inform the CCDs 216 abd 218 to capture the required 1200 dpi data and then merge two points of data into one in the CCDs 216 and 218 to output 600 dpi image data Di1 and Di2. The 600 dpi image data Di1 and Di2 are respectively converted by the AFEs 212 and 214 into 600 dpi digital signals Sd1 and Sd2 and then are sent back to the ASIC 210. Therefore, the image data generated in duplex scan can be processed by using a single ASIC, thereby achieving the purpose of reducing the cost.

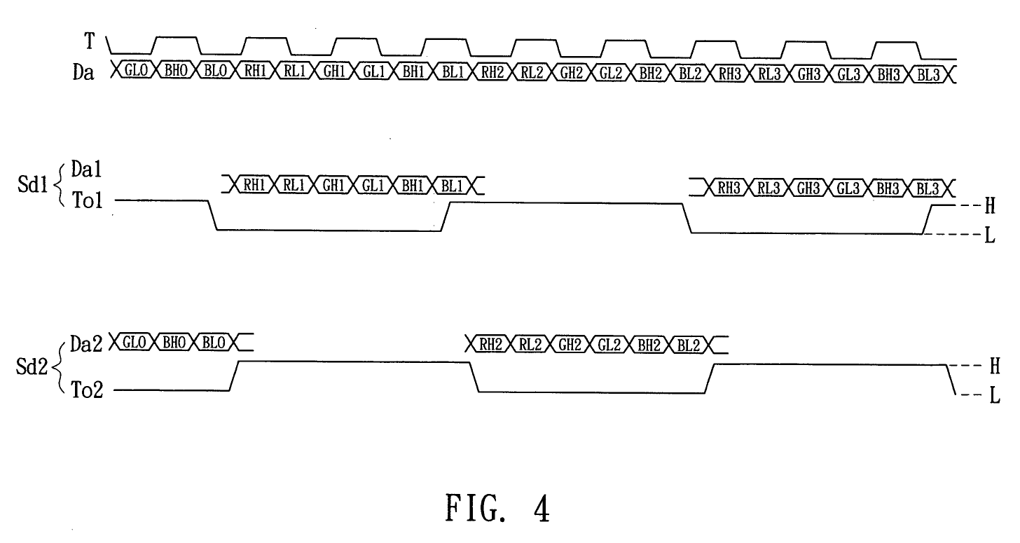

Referring to FIG. 4, a comparison diagram of the timing T sent out by the ASIC and the signals Sd1 and Sd2 sent back by the AFEs according to the preferred embodiment of the invention is shown. As shown in FIG. 4, the timing T sent out by the ASIC requests the CCDs 216 and 218 to provide data Da of a constant amount (for example, 1200 dpi). The AFEs 212 and 214 respectively send back the signals Sd1 and Sd2 including digital data Da1 and Da2, and clock signals To1 and To2 controlled by the OE1 and OE2. According to the control of the clock signals To1 and To2, the digital data Da1 or Da2 are not sent out as the clock signal To1 or To2 is at a high level H while the digital data Da1 or Da2 are sent out as the clock signal To1 or To2 is at a low level L. Therefore, the data Da requested by the ASIC 210 are provided by the digital data Da1 and Da2 in turn as shown in FIG. 4. It is noted that when the clock signal To1 and To2 are six times the period of the timing T, the AFEs 212 and 214 respectively delete six data points for each six points. Finally, the data Da received by the ASIC 210 include six points of data Da1 (including two points of red, blue and green pixels) and six points of data Da2 (including two points of red, blue and green pixels), arranged in turn.

Besides, when the duplex scan apparatus 200 performs a single image scan, the data deletion operation controlled by the OE1 or OE2 is not required. That is, the ASIC 210 sends out the timing T of 1200 dpi, and the CCD 216 or 218 captures 1200 dpi data Di1 or Di2, while the data Di1 or Di2 are converted into 1200 dpi digital Da1 or Da2 and then sent back to the ASIC 210.

The duplex scan apparatus according to the above-mentioned embodiment of the invention has the following advantages. By using a single ASIC to simultaneously process the image data generated in duplex scan and using the OE to control the data deletion operation or performing a merging operation in the CCD, at least 20% of material cost on the circuit board can be saved and production efficiency can be increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A duplex scan apparatus, for simultaneously scanning a first face and a second face of a to-be-scanned document, the duplex scan apparatus comprising:
an application specific integrated circuit (ASIC), for outputting timing;
a first charge coupled device (CCD), for sensing the first face of the to-be-scanned document and outputting a plurality of first image data according to the timing;
a second CCD, for sensing the second face of the to-be-scanned document and outputting a plurality of second image data according to the timing;
a first analog front end (AFE), for converting the first image data into a plurality of first digital data and outputting the digital data to the ASIC for processing; and
a second AFE, for converting the second image data into a plurality of second digital data and outputting the digital data to the ASIC for processing;
wherein a constant data amount corresponding to the timing is a sum of a first data amount of the first digital data and a second data amount of the second digital data.

2. The duplex scan apparatus according to claim 1, wherein the first CCD and the second CCD respectively capture and output the first image data of a constant data amount and the second image data of a constant data amount according to the timing.

3. The duplex scan apparatus according to claim 2, wherein the first AFE and the second AFE respectively include a first output enable (OE) port and a second OE port, controlled by the ASIC, for performing a data deletion operation on the first image data and the second image data.

4. The duplex scan apparatus according to claim 3, wherein in the data deletion operation, the first OE port and the second OE port respectively delete a constant data points of the first image data and the second image data every the same constant amount of data.

5. The duplex scan apparatus according to claim 4, wherein the first OE port and the second OE port respectively output a first clock signal and a second clock signal to perform the data deletion operation, and the first clock signal and the second clock signal are not simultaneously at a high level output or a low level output.

6. The duplex scan apparatus according to claim 5, wherein the first image data and the second image data corresponding to one of the high level output and the low level output are deleted while the first image data and the second image date corresponding to the other are respectively converted into the first digital data and the second digital data.

7. The duplex scan apparatus according to claim 1, wherein the first CCD and the second CCD capture data of the constant data amount and perform a merging operation by merging two data points into one point to generate the first image data and the second image data according to the timing.

8. The duplex scan apparatus according to claim 1, wherein the ASIC performs data processing on the first digital data and the second digital data in turn.

9. The duplex scan apparatus according to claim 1, wherein the ASIC performs data processing on one group of the first digital data and the second digital data first and then the other group.

10. The duplex scan apparatus according to claim 1, wherein the first data amount is equal to the second data amount.

11. The duplex scan apparatus according to claim 1, wherein when the duplex scan apparatus performs a single image scan on the to-be-scanned document, the constant data amount corresponding to the timing is the first data amount of the first digital data or the second data amount of the second digital data.
